(19) United States
(12) Patent Application Publication
(10) Pub. No.: US 2008/0242771 A1
(43) Pub. Date: Oct. 2, 2008

(54) Butyl Rubber Composition for Tire Treads

(76) Inventors: Kevin Kulbaba, Sarnia (CA); Rui Resendes, Corunna (CA); Carl Walter Von Hellens, Bright's Grove (CA)

Correspondence Address: Jennifer R. Seng;Lanxess Corporation, Law & Intellectual Property Department, 111 RIDC Park West Drive, Pittsburgh, PA, 15275-1112, US

(21) Appl. No.: 10/582,603

(22) PCT Filed: Dec. 10, 2004
(86) PCT No.: PCT/CA04/02104

§ 371 Date: Sep. 10, 2007

(30) Foreign Application Priority Data
Dec. 12, 2003 (CA) 2,452,910

(51) Int. Cl. C08K 3/04; C08L 19/00

(52) U.S. Cl. 524/68; 524/519; 524/515

(57) ABSTRACT

The present invention relates to a method of improving the hardness and abrasion resistance while maintaining the useful dynamic properties inherent to butyl based tire tread compounds by adding HXNBR to a rubber composition comprising at least one butyl elastomer for a tire tread, in particular a tire tread suitable for a pneumatic tire.

### TECHNICAL FIELD

The present invention relates to a method of improving the hardness and abrasion resistance while maintaining the useful dynamic properties inherent to butyl based tire tread compounds by adding HXNBR to a rubber composition comprising at least one butyl elastomer for a tire tread, in particular a tire tread suitable for a pneumatic tire.

### BACKGROUND ART

Tire tread development has focussed on maximizing a variety of significant physical properties, of which rolling resistance, wet traction and wear resistance are considered to be the most important. It has long been known that the incorporation of butyl elastomers into tread compounds can have a positive effect on tread properties due to the unusual dynamic properties of the butyl elastomers. For example, the incorporation of BIIR into treads has been shown to improve both wet traction and rolling resistance based on laboratory tests. Such properties make the incorporation of butyl into treads highly attractive to tire manufacturers, however the wear properties and the hardness of the resulting compounds can be very poor, resulting in a severely shortened lifetime of the final product (see for example U.S. Pat. No. 2,698,041, GB-A-2,072,576 and EP-A1-0 385 760).

Reinforcing fillers such as carbon black and silica are typically used to improve the strength and fatigue properties of elastomeric compounds. In the case of butyl based elastomers, there is only relatively poor filler interactions with black fillers due in part to a reduction of unsaturated sites along the polymer backbone. To overcome this apparent limitation, the coupling of BIIR to filler particles has been shown to be an effective way to improve the reinforcement of BIIR with silica fillers leading to a reduction in rolling resistance and improved abrasion resistance of such compounds. See for example Canadian Patent Application 2,293,149 and co-pending applications CA 2,339,080, CA-2,412,709 and CA-2,368,363. Due to the inherent low glass transition temperature of butyl polymers, the hardness of such compounds may still be too low for tread applications.

U.S. Pat. No. 6,218,473 claims a sulfur curable rubber composition of chlorosulfonated polyethylene and carboxylated nitrile rubbers added to basic tread compound for improved wear and tear characteristics.

A sulfur cured rubber composition containing epoxidized natural rubber and carboxylated nitrile rubbers for tear and abrasion resistance improvements for pneumatic tires has been patented. (see for example U.S. Pat. No. 5,489,628, U.S. Pat. No. 5,462,979, U.S. Pat. No. 5,489,627 and U.S. Pat. No. 5,488,077)

EP 0390012A1 claims a tire tread composition consisting of crosslinked rubber containing 20 to 50% ionic and from 80 to 50% covalent crosslinks. These treads exhibit improved wear, lower rolling resistance, lower hysteresis and increased strength properties.

All of the aforementioned patent claims use unsaturated carboxylated nitrile rubber and do not teach the use and benefits of a hydrogenated carboxylated nitrile in such applications.

U.S. Pat. No. 4,990,570 claims a curable rubber composition containing a hydrogenated nitrile rubber, a zinc salt of methacrylic acid, silicic anhydride and an organic peroxide. The cured product is said to possess excellent strength, abrasion resistance and compression set. The benefits of a hydrogenated carboxylated nitrile rubber have not been explored.

### SUMMARY OF THE INVENTION

It has now been found that rubber blends and vulcanized rubber products with surprisingly improved dynamic damping properties in the temperature range relevant to wet grip and in the temperature range relevant to rolling resistance, as well as improved abrasion behaviour, can be prepared from rubber compounds comprising at least one butyl rubber and at least one hydrogenated carboxylated nitrile rubber.

Thus in one aspect, the present invention provides a rubber composition comprising at least one, optionally halogenated, butyl rubber and at least one hydrogenated carboxylated nitrile rubber.

In another aspect, the present invention provides a rubber composition comprising at least one, optionally halogenated, butyl rubber and at least one hydrogenated carboxylated nitrile rubber and at least one filler.

In yet another aspect, the present invention provides a rubber composition comprising at least one, optionally halogenated, butyl rubber and at least one hydrogenated carboxylated nitrile rubber and at least one vulcanizing agent.

In yet another aspect, the present invention provides a rubber composition comprising at least one, optionally halogenated, butyl rubber, at least one hydrogenated carboxylated nitrile rubber, at least one filler and at least one vulcanizing agent.

In yet another aspect, the present invention provides a rubber composition for a tire tread comprising at least one, optionally halogenated, butyl rubber, at least one hydrogenated carboxylated nitrile rubber, at least one filler and at least one vulcanizing agent.

In yet another aspect, the present invention provides a method of improving the wet traction of a tire tread comprising at least one, optionally halogenated, butyl rubber, at least one filler and at least one vulcanizing agent by adding at least one hydrogenated carboxylated nitrile rubber to the compound and vulcanizing the compound.

### DETAILED DESCRIPTION OF THE INVENTION

With respect to the one, optionally halogenated, butyl rubber used in the composition, any known halogenated or non-halogenated butyl rubber suitable for tire manufacture can be used.

The phrase “halogenated butyl rubber” as used herein refers to a chlorinated or brominated butyl elastomer. Brominated butyl elastomers are preferred, and the invention is illustrated, by way of example, with reference to such bromobutyl elastomers (“BIIR”). It should be understood, however, that the invention extends to the use of chlorinated butyl elastomers (“CIR”).

Thus, halobutyl elastomers suitable for use in the practice of this invention include, but are not limited to, brominated butyl elastomers. Such elastomers may be obtained by bromination of non-halogenated butyl rubber.

The phrase “non-halogenated butyl rubber” as used herein refers to a copolymer of isobutylene and a co-monomer that is usually a C₄ to C₆ conjugated diolefin, preferably isoprene—(isobutene-isoprene-copolymers “IIR”)). Co-monomers other than conjugated diolefins can be used, however, and mention is made of alkyl-substituted vinyl aromatic co-monomers such as C₁-C₄-alkyl substituted styrene. An example of such a (in this case brominated) elastomer which is commercially available is brominated isobutylene methylstyrene copolymer (BIMS) in which the co-monomer is p-methylstyrene.

Preferred butyl elastomers comprise in the range of from 0.1 to 10 weight percent of repeating units derived from isoprene and in the range of from 90 to 99.9 weight percent of repeating units derived from isobutylene (based upon the hydrocarbon content of the polymer) and, in case the IIR is brominated, in the range of from 0.1 to 9 weight percent bromine (based upon the bromobutyl polymer). A typical bromobutyl polymer has a molecular weight, expressed as the Mooney viscosity according to DIN (Deutsche Industrie Norm) 53 523 (ML 1+8 at 125° C.), in the range of from 25 to 60.

For use in the present invention the brominated butyl elastomer more preferably contains in the range of from 0.5 to 5 weight percent of repeating units derived from isoprene and in the range of from 95 to 99.5 weight percent of repeating units derived from isobutylene (based upon the hydrocarbon content of the polymer) and, in case it is brominated, in the range of from 0.2 to 3 weight percent, most preferably from 0.75 to 2.3 weight percent, of bromine (based upon the brominated butyl polymer).

Examples of suitable butyl elastomers include Bayer® Butyl™ 100, Bayer® Butyl™ 101-3, Bayer® Butyl™ 301, and Bayer® Butyl™ 402 commercially available from Bayer Inc. Bayer® Butyl™ 301 has a Mooney viscosity (RPML 1+8 (125° C. according to ASTM D 52-89) of 51±5, an residual double bond content of 1.85 mol % and an average molecular weight Mw of 550,000 grams per mole. Bayer® Butyl™ 402 has a Mooney viscosity RPML 1+8@ 125° C. according to ASTM D 52-89) of 33+4, an residual double bond content of 2.25 mol % and an average molecular weight Mw of 430,000 grams per mole.

Examples of suitable brominated butyl elastomers include Bayer® Bromobutyl™ 2030, Bayer® Bromobutyl™ 2040 (BB2040), and Bayer® Bromobutyl™ X2 commercially available from Bayer Inc. Bayer® BB2040 has a Mooney viscosity (ML 1+8 @ 125° C.) of 39±4, a bromine content of 2.0±0.3 wt % and an approximate molecular weight of 500,000 grams per mole.

Hydrogenated nitrile rubber (HNBR), prepared by the selective hydrogenation of nitrile rubber BR, a co-polymer comprising repeating units derived from at least one conjugated diene, at least one unsaturated nitrile and optionally further comonomers), and hydrogenated carboxylated nitrite rubber (BR), prepared by the selective hydrogenation of carboxylated nitrite rubber (XNBR), a, preferably statistical, ter-polymer comprising repeating units derived from at least one conjugated diene, at least one unsaturated nitrile, at least one conjugated diene having a carboxylic group (e.g an alpha-beta-unsaturated carboxylic acid) and optionally further comonomers are specialty rubbers which have very good heat resistance, excellent ozone and chemical resistance, and excellent oil resistance.

Coupled with the high level of mechanical properties of the rubber (in particular the high resistance to abrasion) it is not surprising that HXNBR and HNBR have found widespread use in the automotive (seals, hoses, bearing pads) oil (stators, well head seals, valve plates), electrical (cable sheathing), mechanical engineering (wheels, rollers) and shipbuilding (pipe seals, couplings) industries, amongst others.

HXNBR and a method for producing it is for example known from WO-01/7185-A1 which is hereby incorporated by reference with regard to jurisdictions allowing for this procedure.

As used throughout this specification, the term “carboxylated nitrite rubber” or XNBR is intended to have a broad meaning and is meant to encompass a copolymer having repeating units derived from at least one conjugated diene, at least one alpha,beta-unsaturated nitrile, at least one alpha-beta-unsaturated carboxylic acid or alpha,beta-unsaturated carboxylic acid derivative and optionally further one or more copolymerizable monomers.

As used throughout this specification, the term “hydrogenated” or HXNBR is intended to have a broad meaning and is meant to encompass an XNBR wherein at least 10% of the residual C—C double bonds (RDB) present in the starting XNBR are hydrogenated, preferably more than 50% of the RDB present are hydrogenated, more preferably more than 90% of the RDB are hydrogenated, and most preferably more than 95% of the RDB are hydrogenated.

The conjugated diene may be any known conjugated diene in particular a C₄-C₆ conjugated diene. Preferred conjugated dienes are butadiene, isoprene, piperylene, 2,3-dimethyl butadiene and mixtures thereof. Even more preferred C₄-C₆ conjugated dienes are butadiene, isoprene and mixtures thereof. The most preferred C₄-C₆ conjugated diene is butadiene.

The alpha,beta-unsaturated nitrile may be any known alpha,beta-unsaturated nitrile, in particular a C₃-C₅ alpha,beta-unsaturated nitrile. Preferred C₃-C₅ alpha,beta-unsaturated nitriles are acrylonitrile, methacrylonitrile, ethacrylonitrile and mixtures thereof. The most preferred C₃-C₅ alpha,beta-unsaturated nitrile is acrylonitrile.

The alpha,beta-unsaturated carboxylic acid may be any known alpha,beta-unsaturated acid copolymerizable with the diene(s) and the nitrile(s), in particular acrylic, methacrylic, ethacrylic, crotonic, maleic, fumaric or itaconic acid, of which acrylic and methacrylic are preferred.

The alpha,beta-unsaturated carboxylic acid derivative may be any known alpha,beta-unsaturated acid derivative copolymerizable with the diene(s) and the nitile(s), in particular esters, amides and anhydrides, preferably esters and anhydrides of acrylic, methacrylic, ethacrylic, crotonic, maleic, fumaric or itaconic acid.

Preferably, the HXNBR comprises in the range of from 39.1 to 80 weight percent of repeating units derived from one or more conjugated dienes, in the range of from 5 to 60 weight percent of repeating units derived from one more unsaturated nitrites and 0.1 to 15 percent of repeating units derived from one or more unsaturated carboxylic acid or acid derivative. More preferably, the HXNBR comprises in the range of from 60 to 70 weight percent of repeating units derived from one or more conjugated dienes, in the range of from 20 to 39.5 weight percent of repeating units derived from one or more unsaturated nitrites and 0.5 to 10 percent of repeating units derived from one or more unsaturated carboxylic acid or acid derivative. Most preferably, the HXNBR comprises in the range of from 56 to 69.5 weight percent of repeating units derived from one or more conjugated dienes, in the range of from 30 to 37 weight percent of repeating units derived from one or more unsaturated nitrites and 0.5 to 7 percent of repeating units derived from one or more unsaturated carboxylic acid or acid derivative. Preferably said HXNBR is a statistical co-polymer with in particular the carboxylic functions randomly distributed throughout the polymer chains.

Optionally, the HXNBR may further comprise repeating units derived from one or more copolymerizable monomers. Repeating units derived from one or more copolymerizable monomers will replace either the nitrile or the diene portion of the nitrile rubber and it will be apparent to the skilled in the art that the above mentioned figures will have to be adjusted to result in 100 weight percent.

Preferred HXNBR are available from Bayer AG under the tradename TBERBAN® XT™ VP KA 8889.

The composition of the inventive rubber compound may vary in wide ranges and in fact it is possible to tailor the properties of the resulting compound by varying the ratio HXNBR(s)/HNBR(s). The compound preferably comprises in the range of from 0.1-30 wt. %, of HXNBR(s), more preferably from 1-20, most preferably from 2-10 wt. %

The Mooney viscosity of the rubbers can be determined using ASTM test D1646.

The HXNBR(s) comprised in the inventive compound are not restricted. However, preferably they have a Mooney viscosity (ML 1+4 @ 100° C.) above 30.

Blending of two or more rubber polymers having a different Mooney viscosity will usually result in a blend having a bi-modal or multi-modal molecular weight distribution. According to the present invention, the final blend has preferably at least a bi-modal molecular weight distribution.

In order to provide a vulcanizable rubber compound, at least one vulcanizing agent or curing system has to be added. The invention is not limited to a special curing system, however, sulfur curing system(s) are preferred. The preferred amount of sulfur is in the range of from 0.3 to 2.0 phr (parts by weight per hundred parts of rubber). An activator, for example zinc oxide, may also be used, in an amount in the range of from 5 parts to 0.5 parts by weight. Other ingredients, for instance stearic acid, oils (e.g. Sunpar® of Sunoco), antioxidants, or accelerators (e.g. a sulfur compound such as dibenzothiazyldisulfide (e.g. Vulkacit® DM/C of Bayer AG) may also be added to the compound prior to curing. Sulphur curing is then effected in known manner. See, for instance, chapter 2, “The Compounding and Vulcanization of Rubber”, of “Rubber Technology”, 3^{rd} edition, published by Chapman & Hall, 1995.

Preferably the composition furthermore comprises 5 to 500, more preferably 40 to 100 parts by weight per hundred parts by weight rubber (phr) of an active or inactive filler or a mixture thereof.

The filler may be in particular:
highly dispersed silicas, prepared e.g. by the precipitation of silicate solutions or the flame hydrolysis of silicon halides, with specific surface areas of in the range of from 5 to 1000 m²/g, and with primary particle sizes of in the range of from 10 to 400 nm; the silicas can optionally also be present as mixed oxides with other metal oxides such as those of Al, Mg, Ca, Ba, Zn, Zr and Ti;
synthetic silicates, such as aluminum silicate and alkaline earth metal silicate like magnesium silicate or calcium silicate, with BET specific surface areas in the range of from 20 to 400 m²/g and primary particle diameters in the range of from 10 to 400 nm;
natural silicates, such as kaolin and other naturally occurring silica;
glass fibers and glass fiber products (matting, extrudates) or glass microspheres;
metal oxides, such as zinc oxide, calcium oxide, magnesium oxide and aluminum oxide;
metal carbonates, such as magnesium carbonate, calcium carbonate and zinc carbonate;
metal hydroxides, e.g. aluminum hydroxide and magnesium hydroxide;
carbon blacks; the carbon blacks to be used here are prepared by the lamp black, furnace black or gas black process and have preferably BET (DIN 66 131) specific surface areas in the range of from 20 to 200 m²/g, e.g. SAF, ISAF, HAF, FEF or GPF carbon blacks;
rubber gels, especially those based on polybutadiene, butadiene/styrene copolymers, butadiene/acrylonitrile copolymers and polychloroprene;

or mixtures thereof.

Examples of preferred mineral fillers include silica, silicates, clay such as bentonite, gypsum, alumina, titanium dioxide, talc, mixtures of these, and the like. These mineral particles have hydroxyl groups on their surface, rendering them hydrophilic and oleophobic. This exacerbates the difficulty of achieving good interaction between the filler particles and the rubber. For many purposes, the preferred mineral is silica, especially silica made by carbon dioxide precipitation of sodium silicate. Dried amorphous silica particles suitable for use in accordance with the invention may have a mean agglomerate particle size in the range of from 1 to 100 microns, preferably between 10 and 50 microns and most preferably between 10 and 25 microns. It is preferred that less than 10 percent by volume of the agglomerate particles are below 5 microns or over 50 microns in size. A suitable amorphous dried silica moreover usually has a BET surface area, measured in accordance with DIN 66131, of in the range of from 50 and 450 square meters per gram and a DBP absorption, as measured in accordance with DIN 53601, of in the range of from 150 and 400 grams per 100 grams of silica, and a drying loss, as measured according to DIN ISO 787/11, of in the range of from 0 to 10 percent by weight. Suitable silica fillers are available under the trademarks HiSil® 210, HiSil® 233 and HiSil® 243 from PPG Industries Inc. Also suitable are Vulkasil® S and Vulkasil® N, from Bayer AG.

Often, use of carbon black as filler is advantageous. Usually, carbon black is present in the polymer blend in an amount of in the range of from 20 to 200 parts by weight, preferably 30 to 150 parts by weight, more preferably 40 to 100 parts by weight. Further, it might be advantageous to use a combination of carbon black and mineral filler in the inventive vulcanizable rubber compound. In this combination the ratio of mineral fillers to carbon black is usually in the range of from 0.05 to 20, preferably 0.1 to 10.

The vulcanizable rubber compound may further comprise other natural or synthetic rubbers such as BR (polybutadiene), preferably BR of the Taktene™ product family available from Bayer AG, ABR (butadiene/acrylic acid-C₁-C₄-alkylester-copolymers), EVM (ethylene vinyl acetate-copolymers), NBR (butadiene/acrylonitrile copolymers), AEM (ethylene acrylate-copolymers), CR (polychloroprene), IR (polyisoprene), SBR (styrene/butadiene-copolymers) with styrene contents in the range of 1 to 60 wt %, EPDM (ethylene/propylene/diene-copolymers), FKM (fluoropolymers or fluororubbers), and mixtures of the given polymers. Careful blending with said rubbers often reduces cost of the polymer blend without sacrificing the processability. The amount of natural and/or synthetic rubbers will depend on the process condition to be applied during manufacture of shaped articles and is readily available by few preliminary experiments. Among the diene synthetic rubbers, a high-cis BR is particularly preferable, and in the case of a combination of the natural rubber (NR) and the high-cis BR, a ratio of the natural rubber (NR) to the high-cis BR is 80/20 to 30/70, preferably 70/30 to 40/60. In addition, the amount of the combination of the natural rubber and the high-cis BR is 70% by weight or more, preferably 80% by weight or more, more preferably 85% by weight or more.

Furthermore, the following rubbers are of particular interest for the manufacture of motor vehicle tyres with the aid of surface-modified fillers: natural rubber, emulsion SBRs and solution SBRs with a glass transition temperature above −50° C., which can optionally be modified with silyl ethers or other functional groups, such as those described e.g. in EP-A 447,066, polybutadiene rubber with a high 1,4-cis content (>90%), which is prepared with catalysts based on Ni, Co, Ti or Nd, and polybutadiene rubber with a vinyl content of 0 to 75%, as well as blends thereof. In one preferred embodiment, the inventive compound comprises HXNBR and SBR. The preferred SBR content in the compound is in the range of from 50 to 99 phr.

The vulcanizable rubber compound according to the invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc., which are known to the rubber industry. The rubber aids are used in conventional amounts, which depend inter alia on the intended use. Conventional amounts are e.g. from 0.1 to 50 phr. Preferably the vulcanizable compound comprising said solution blend further comprises in the range of 0.1 to 20 phr of one or more organic fatty acids as an auxiliary product, preferably a unsaturated fatty acid having one, two or more carbon double bonds in the molecule which more preferably includes 10% by weight or more of a conjugated diene acid having at least one conjugated carbon-carbon double bond in its molecule. Preferably those fatty acids have in the range of from 8-22 carbon atoms, more preferably 12-18. Examples include stearic acid, palmitic acid and oleic acid and their calcium-, zinc-, magnesium-, potassium- and ammonium salts. Furthermore up to 40 parts of processing oil, preferably from 5 to 20 parts, per hundred parts of elastomer, may be present.

It may be advantageous to add one or more silazane compounds to the inventive compound. These siliazane compound(s) can have one or more silazane groups, e.g. disilazanes. Organic silazane compounds are preferred. Examples include but are not limited to hexamethyldisilazane, heptamethyldisilazane, 1,1,3,3-tetramethyldisilazane, 1,3-bis(chloromethyl)tetramethyldisilazane, 1,3-divinyl-1,1,3,3-tetramethyldisilazane, and 1,3-diphenyltetramethyldisilazane.

It may be advantageous to further add additives, which give enhanced physical properties to the inventive compound such as hydroxyl- and amine-containing additives. Examples of hydroxyl- and amine-containing additives include but are not limited to proteins, aspartic acid, 6-aminocaproic acid, diethanolamine and triethanolamine. Preferably, the hydroxyl- and amine-containing additive should contain a primary alcohol group and an amine group separated by methylene bridges, which may be branched. Such compounds have the general formula HO-A-NH₂; wherein A represents a C₁ to C₂₀ alkylene group, which may be linear or branched.

More preferably, the number of methylene groups between the two functional groups should be in the range of from 1 to 4. Examples of preferred additives include monoethanolamine and N,N-dimethylaminoalcohol.

It may be advantageous to further add silica modifying silanes, which give enhanced physical properties to the inventive compound. Compounds of this type possess a reactive silylether functionality (for reaction with the silica surface) and a rubber-specific functional group. Examples of these modifiers include, but are not limited to bis(trimethoxysilylpropyl)tetrasulfane, bis(trimethoxysilylpropyl)disulfane, bis(triethoxylsilylpropyl)tetrasulfane, bis(triethoxysilylpropyl)disulfance, thioacetic acid S-trimethoxysilyl-methyl ester, thioacetic acid S-triethoxysilyl-methyl ester, thioacetic acid S-(2-trimethoxylsilyl-ethyl) ester, thioacetic acid S-(2-triethoxysilyl-ethyl) ester, thioacetic acid S-(3-trimethoxysilyl-propyl) ester, thioacetic acid S-(3-triethoxysilyl-propyl) ester, thiopropionic acid S-trimethoxylsilyl-methyl ester, thiopropionic acid S-triethoxylsilyl-methyl ester, thiopropionic acid S-(2-trimethoxylsilyl-ethyl) ester, thiopropionic acid S-(2-triethoxylsilyl-ethyl) ester, thiopropionic acid S-(3-trimethoxylsilyl-propyl) ester, thiopropionic acid S-(3-triethoxylsilyl-propyl) ester, thiobutyric acid S-trimethoxysilyl-methyl ester, thiobutyric acid S-triethoxysilyl-methyl ester, thiobutyric acid S-(2-trimethoxysilyl-ethyl) ester, thiobutyric acid S-(2-triethoxysilyl-ethyl) ester, thiobutyric acid S-(3-trimethoxysilyl-propyl) ester, thiobutyric acid S-(3-triethoxysilyl-propyl) ester, pentanethioic acid S-trimethoxysilyl-methyl ester, pentanethioic acid S-triethoxysilyl-methyl ester, pentanethioic acid S-(2-trimethoxysilyl-ethyl) ester, pentanethioic acid S-(2-triethoxysilyl-ethyl) ester, pentanethioic acid S-(3-trimethoxysilyl-propyl) ester, and pentanethioic acid S-(3-triethoxysilyl-propyl) ester. Preferred are pentanethioic acid S-(3-trimethoxysilyl-propyl) ester, and pentanethioic acid S-(3-triethoxysilyl-propyl) ester.

The amount of the silazane compound is preferably in the range of from 0.5 to 10 parts per hundred parts of elastomer, preferably of from 1 to 6, more preferably of from 2 to 5 parts per hundred parts of elastomer. The amount of hydroxyl- and amine-containing additive used in conjunction with the silazane compound is typically in the range of from 0.5 to 10 parts per hundred parts of elastomer, preferably of from 1 to 3 parts per hundred parts of elastomer. The amount of silica modifying silane is preferably in the range of from 0.5 to 15 parts per hundred parts of elastomer, preferably from 1 to 10, more preferably from 2 to 8 parts per hundred parts of elastomers. The silica modifying silane can be used alone or in conjunction with a silazane compound or in conduction with a hydroxyl- and amine-containing additive or in conduction with a silazane compounds and a hydroxyl- and amine-containing additive.

The ingredients of the final vulcanizable rubber compound comprising said rubber compound are often mixed together, suitably at an elevated temperature that may range from 25° C. to 200° C. Normally the mixing time does not exceed one hour and a time in the range from 2 to 30 minutes is usually adequate. Mixing is suitably carried out in an internal mixer such as a Banbury mixer, or a Haake or Brabender miniature internal mixer. A two roll mill mixer also provides a good dispersion of the additives within the elastomer. An extruder also provides good mixing, and permits shorter mixing times. It is possible to carry out the mixing in two or more stages, and the mixing can be done in different apparatus, for example one stage in an internal mixer and one stage in an extruder. However, it should be taken care that no unwanted pre-crosslinking (=scorch) occurs during the mixing stage. For compounding and vulcanization see also: Encyclopedia of Polymer Science and Engineering, Vol. 4, p. 66 et seq. (Compounding) and Vol. 17, p. 666 et seq. (Vulcanization).

The addition of HXNBR to a compound suitable for a tire tread comprising at least one, optionally halogenated, butyl rubber, at least one filler and at least one vulcanizing agent vulcanizing the compound results in improving the wet traction and abrasion resistance while reducing the rolling resistance of said tire tread.

Dynamic Mechanical property measurements at the correct strain conditions have been shown to correlate to both wet traction and rolling resistance behavior of the tire tread. In particular, the measurement of tan delta at 0° C. predicts the wet grip characteristics while the same measurement at 60° C. is routinely used to measure rolling resistance of a tire. The latter can also be estimated by measuring the loss modulus G″ at the same temperature. Wear characteristics of a tread compound are best predicted in the laboratory by using DIN or Taber type abrasion testing, both given an indication of a rubbing type abrasion. Pico abrasion is also commonly used as a measure of cutting abrasion resistance.

While specific emphasis has been put on the tread, it is believed that the present invention is useful in all types of tire components as well as other shaped articles such as a seal, O-ring, hose, bearing pad, stator, well head seal, valve plate, cable sheathing, wheel roller, pipe seal, in place gaskets or footwear component and shaped articles intended for vibration dampening.

The following examples are provided to illustrate the present invention:

### EXAMPLES

### Experimental Details

### Cure Rheometry:

Vulcanization was followed on a Moving Die Rheometer (MDR 2000 (E)) using a frequency of oscillation of 1.7 Hz and a 1°arc at 170° C. for 30 minutes total run time. The test procedure follows ASTM D-5289.

### Compound Mooney Viscosity and Scorch.

A large rotor was used for these tests in compliance with the ASTM method D-1646. The compound Mooney viscosity was determined at 100° C. by preheating the sample 1 minute and then, measuring the torque (Mooney viscosity units) after 4 minutes of shearing action caused by the viscometer disk rotating at 2 r.p.m. Mooney scorch measurements taken as the time from the lowest torque value to a rise of 5 Mooney units (t05) were carried out at 125° C. and 135° C.

### Green Strength

Die C cut dumbbell samples are cut out of a molded, unvulcanized rubber sample and then pulled on a tensile tester at room temperature. The resultant force and elongations are measured upon extension of the dumbbell sample.

### Hardness and Stress Strain Properties

An A-2 type durometer was used following ASTM D-2240 requirements for the hardness measurement. This stress strain data was generated at 23° C. according to the requirements of ASTM D-412 Method A. Die C dumbbells cut from 2 mm thick tensile sheets were used.

### Din Abrasion:

Abrasion resistance is determined according to test method DIN 53 516. The volume loss by rubbing the rubber specimen with an emery paper of defined abrasive power is measured and reported.

### GABO Eplexor

Dynamic properties were determined by means of a GABO Eplexor tester. The test specimen is subjected to a small sinusoidal deformation at a particular frequency and the temperature is varied. The resulting stress and phase difference between the imposed deformation and the response are measured and recorded.

### Raw Materials Used

| | |
|---|---|
| BAYER ® BROMOBUTYL ™ 2030 | available from Bayer Inc. |
| TAKTENE ™ 1203-G1 | available from Bayer AG |
| HEXAMETHYLDISILAZANE | available from Aldrich |
| THERBAN ® XT ™ VP KA 8889 | available from Bayer AG |
| HI-SIL 233 | available from PPG Industries |
| DIMETHYLETHANOLAMINE | available from Aldrich |
| CARBON BLACK, N 234 VULCAN 7 | available from Cabot Industries |
| STEARIC ACID EMERSOL 132 NF | available from Acme Hardesty |
| | Co |
| CALSOL 8240 | available from R. E. Carrol Inc. |
| Sunolite 160 Prills | available from Witco Corp. |
| VULKANOX ™ 4020 LG (6PPD) | available from Bayer AG |
| VULKANOX ™ HS/LG | available from Bayer AG |
| SULFUR (NBS) | available from NIST |
| VULKACIT ™ NZ/EG-C (CBS) | available from Bayer AG |
| ZINC OXIDE | available from St. Lawrence |
| | Chemical Co. |

### General Compounding Procedure

The rubbers were mixed in a 1.6 liter Banbury internal tangential mixture (BR-82) with the Mokon set to 30° C. and a rotor speed of 77 RPM. The start temperature was 30° C. and the RAM pressure was 30 psi. BB 2030 and Taktene™ 1203 were added and mixed for 0.5 minutes, then Hexamethyldisilazane, HiSil®, and the Dimethylethanolamine were added and the mixing continued for 1.5 minutes. Carbon black, stearic acid and (if present) Therban™ XT were added and the mixing continued for 1 minute. Materials were then swept off of ram and lower tray into the internal mixer to ensure complete incorporation of all dry components into compound. 3.5 minutes after the start of the mixing procedure, Calsol, Sunolite, Vulkaox™ 4020 LG and HS/LG were added to the compound and the compound was mixed for another 2.5 minutes. To the cooled sample, the sulfur, Vulkacit™ NZ and zinc oxide were added on a 10″×20″ mill with the Mokon set to 30° C. Several three quarter cuts were performed to homogenize the curatives into the masterbatch followed by a minimum of six end-wise passes of the compound.

### Examples 1-4

Four rubber compounds were prepared using the ingredients in phr (per hundred rubber) stated in Table 1 and the general mixing procedure. Example 1 is for comparison reasons.

TABLE 1

| | 1 | 2 | 3 | 4 |
|---|---|---|---|---|
| Bayer ® Bromobutyl ™ 2030 | 50 | 50 | 50 | 50 |
| Taktene ™ 1203 | 50 | 50 | 50 | 50 |
| Hexamethyldisilazane | 0.73 | 0.73 | 0.73 | 0.73 |
| Hi-Sil ® 233 | 29 | 29 | 29 | 29 |
| Dimethylethanolamine | 1.4 | 1.4 | 1.4 | 1.4 |
| Carbon Black N234 | 30 | 30 | 30 | 30 |
| Stearic Acid | 1.0 | 1.0 | 1.0 | 1.0 |
| Therban ™ XT | 0.0 | 2.0 | 5.0 | 10.0 |
| Calsol 8240 | 7.50 | 7.50 | 7.50 | 7.50 |
| Sunolite 160 Prills | 0.75 | 0.75 | 0.75 | 0.75 |
| Vulkanox ™ 4020 LG | 0.5 | 0.5 | 0.5 | 0.5 |
| Vulkanox ™ HS/LG | 0.5 | 0.5 | 0.5 | 0.5 |
| Sulfur NBS | 1.0 | 1.0 | 1.0 | 1.0 |
| Vulkacit ™ NZ/EG-C | 0.5 | 0.5 | 0.5 | 0.5 |
| Zinc Oxide | 2.0 | 2.0 | 2.0 | 2.0 |

The effect of the various levels of HXNBR on the compound properties was then examined using Stress-Strain and DIN Abrasion measurements. The results of the testing are given in Table 2.

TABLE 2

| | | | |
|---|---|---|---|
| 1 | 2 | 3 | 4 |

COMPOUND MOONEY SCORCH (large rotor)

| | | | | |
|---|---|---|---|---|
| t Value t05 (min) - | 10.85 | 8.51 | 7.57 | 8.73 |
| 125° C. | | | | |

COMPOUND MOONEY VISCOSITY (ML 1 + 4@100° C.)

| | | | | |
|---|---|---|---|---|
| Mooney Viscosity (MU) | 94.6 | 91.8 | 92.3 | 78.5 |

MDR CURE CHARACTERISTICS (1.7 Hz, 170° C., 1° arc, 30 min)

| | | | | |
|---|---|---|---|---|
| MH (dN · m) | 21.61 | 22.44 | 23.41 | 21.99 |
| ML (dN · m) | 6.12 | 5.80 | 6.06 | 5.12 |
| Delta MH-ML (dN · m) | 15.49 | 16.64 | 17.35 | 16.87 |
| ts 1 (min) | 1.14 | 1.32 | 1.26 | 1.08 |
| ts 2 (min) | 2.28 | 2.40 | 2.16 | 1.62 |
| t′ 10 (min) | 1.77 | 2.05 | 1.94 | 1.43 |
| t′ 25 (min) | 4.31 | 4.50 | 3.94 | 2.40 |
| t′ 50 (min) | 9.47 | 8.61 | 7.08 | 3.43 |
| t′ 90 (min) | 38.94 | 32.15 | 26.73 | 6.63 |
| t′ 95 (min) | 47.90 | 42.65 | 37.69 | 8.26 |
| Delta t′50 − t′10 (min) | 7.70 | 6.56 | 5.14 | 2.00 |

STRESS STRAIN (DUMBELLS, die C, 23° C.)

| | | | | |
|---|---|---|---|---|
| Cure Time (min) at | 44 | 37 | 32 | 14 |
| 160° C. | | | | |
| Hardness Shore A2 (pts.) | 56 | 57 | 58 | 58 |
| Ultimate Tensile (MPa) | 12.60 | 14.23 | 14.58 | 17.23 |
| Ultimate Elongation (%) | 533 | 549 | 537 | 735 |
| Stress @ 25 (MPa) | 0.78 | 0.79 | 0.87 | 0.96 |
| Stress @ 50 (MPa) | 1.24 | 1.26 | 1.30 | 1.33 |
| Stress @ 100 (MPa) | 2.27 | 2.32 | 2.35 | 2.05 |
| Stress @ 200 (MPa) | 4.55 | 4.76 | 4.85 | 4.00 |
| Stress @ 300 (MPa) | 7.12 | 7.65 | 7.81 | 6.50 |

DIN ABRASION

| | | | | |
|---|---|---|---|---|
| Cure Time (min) at | 49 | 42 | 37 | 17 |
| 170° C. | | | | |
| Specific Gravity | 1.134 | 1.132 | 1.129 | 1.128 |
| Abrasion Volume Loss | 89 | 75 | 71 | 82 |
| (mm³) | | | | |

DYNAMIC PROPERTIES (GABO Eplexor, 2° C./min rate, 70 rad/sec)

| | | | | |
|---|---|---|---|---|
| tan delta 0° C. | 0.3092 | 0.3163 | 0.3054 | 0.3012 |
| tan delta 60° C. | 0.1339 | 0.1321 | 0.1295 | 0.1277 |
| E″ 60° C. (MPa) | 1.583 | 1.471 | 1.615 | 1.924 |

The slope of the Stress-Strain plot increased only slightly with the addition of low levels of HXNBR. For example the M300/M100 increased from 3.1 to 3.3 with the addition of 2 phr of HXNBR (Example 2).

The reinforcing effect of the HXNBR is most importantly illustrated by the DIN abrasion data. As can be seen from Table 2, the DIN abrasion volume loss for compounds based on 2 or 5 phr of HXNBR (Examples 2 and 3) is significantly lower than that observed for the control compound (Example 1). Furthermore, there is an increase in the hardness of the compounds with increasing HXNBR content.

The Stress-Strain data as well as the DIN abrasion volume loss indicate that the addition of low levels of HXNBR to BIIR containing tread formulations improves the physical reinforcement of the resulting compound. It appears that below 5 phr, the amount of reinforcement will scale with the level of HXNBR present in the tread formulation.

Although both the hardness as well as the reinforcement is improved significantly for these compounds, the Mooney viscosity and the Mooney relaxation of the green compound remained relatively consistent.

From the data presented above it is clear that by incorporating low levels of HXNBR into BIIR containing tread compounds improvements in the hardness and strength of the final compound can be realized. This is of particular value in tread compounds containing BIIR which generally suffer from reduced hardness and strength.

1. Rubber composition comprising at least one, optionally halogenated, butyl rubber and at least one hydrogenated carboxylated nitrile rubber.

2. Rubber composition according to claim 1, characterized in that said rubber composition further comprises at least one filler.

3. Rubber composition according to claim 1 or 2, characterized in that said rubber composition further comprises at least one vulcanizing agent.

4. Rubber composition according to any of claims 1 to 3, characterized in that said rubber composition comprises furthermore a rubber selected from the group consisting of natural rubber, BR, ABR, CR. IR, SBR, NBR, HNBR, EPDM, FKM and mixtures thereof.

5. Rubber composition according to any of claims 1 to 4, characterized in that said filler is selected from the group consisting of carbon black, mineral filler and mixtures thereof.

6. Rubber composition according to any of claims 1 to 5, characterized in that said rubber composition comprises at least one halogenated butyl rubber.

7. Tire tread comprising a rubber composition according to any of claims 1 to 6.

8. In a method of improving the wet traction of a tire tread comprising at least one, optionally halogenated, butyl rubber, at least one filler and at least one vulcanizing agent by adding at least one hydrogenated carboxylated nitrile rubber to the compound and vulcanizing the compound.

9. A shaped article comprising a rubber composition according to any of claims 1 to 6.

10. A process for preparing a rubber composition according to any of claims 1 to 6, wherein at least one, optionally halogenated, butyl rubber and at least one hydrogenated carboxylated nitrile rubber and optionally at least one filler and/or at least one vulcanizing agent are mixed.
